(19) United States
(12) Patent Application Publication
(10) Pub. No.: US 2008/0061647 A1
(43) Pub. Date: Mar. 13, 2008

(54) Electronic Motor

(76) Inventor: Benoit Schmitt, Massy (FR)

Correspondence Address: SCHLUMBERGER OILFIELD SERVICES, 200 GILLINGHAM LANE, MD 200-9, SUGAR LAND, TX, 77478, US

(21) Appl. No.: 11/854,370

(22) Filed: Sep. 12, 2007

(30) Foreign Application Priority Data
Sep. 13, 2006 (EP) EP06291451.0

(51) Int. Cl. H02K 16/00

(52) U.S. Cl. 310/112

(57) ABSTRACT

An electric motor for use in a borehole tool, comprising: a housing; a plurality of stator windings spaced along the inside of the housing; an output shaft located in the housing; a plurality of rotors disposed on the output shaft and aligned with the stators so as to define a plurality of motor sub-units; and separate power supplies and control systems for each motor sub-unit; wherein each motor sub-unit is separately controllable by means of its associated power supply and control system. The output shaft can comprise a single shaft with the rotors disposed thereon or a plurality of sub-shafts connected end to end with each rotor can be disposed on an associated sub-shaft. The sub-shafts can connected by means of articulated connections, and the housing can be articulated in the region of the connections.

### TECHNICAL FIELD

This invention relates to electric motors and specifically to their use in downhole tools such as are used in exploration and production of hydrocarbons.

### BACKGROUND ART

Electric motors are widely used in downhole equipment in the hydrocarbon exploration and production industries. Such motors can be powered via cable from the surface, downhole generators powered by fluid flow, or batteries. A significant limitation concerning the use of electric motors is the limited diameter (OD) available for them to be fitted into downhole equipment, and consequently their limited volume. Current electric motor technology therefore provides a limit to the maximum power that can be provided within this limited volume. There are also thermal limitations for electric motors, the cooling capability mostly being proportional to the external surface of the stator (convection with the well fluid is often the predominant mechanism for heat transfer). Consequently for a given rating of motor, its possible power loss is proportional to its length; at a first order (constant efficiency), this means that the possible mechanical power of such an electric motor is also proportional to its length.

For conventional electric motors used in the oilfield industries (the rotor being internal and the stator being wound internally), winding becomes very challenging when the length of the stator exceeds three times its OD. This means that most such long motors are hand-built as proper production tooling often does not exist to produce such designs. This can result in difficulty in ensuring a proper manufacturing process and for proper inspection of the inner winding for a long stator. U.S. Pat. No. 6,288,470 (CAMCO INT) 11.09.2001 discloses a modular stator for use in an electric motor. The modular stator includes a plurality of stator sections and a plurality of connectors. The plurality of stator sections have conductors extending therethrough with exposed terminal ends. The connectors have corresponding conductive elements with receptacles for receiving the terminal ends. Thus, a given stator may be assembled to a variety of desired lengths by connecting the appropriate number of modular components. U.S. Pat. No. 6,388,353 (CAMCO INT) 14.05.2002 discloses a permanent magnet AC synchronous motor having an elongated housing, of the type used in progressive cavity pumping applications. Within the stator, a multi-section rotor is rotatably mounted. The rotor includes a plurality of rotor sections that are angularly offset from each other. The rotor sections are mounted on a drive shaft, and the sum of the offsets is generally comparable to the angular displacement undergone by the drive shaft under a normal operating load.

An objective of this invention is to provide an electric motor with increased power rating for a given OD. This objective is achieved by providing a motor with multiple, independently controllable stators that are coupled together

### DISCLOSURE OF THE INVENTION

A first aspect of the invention comprises an electric motor for use in a borehole tool, comprising

a housing;

a plurality of stator windings spaced along the inside of the housing;

an output shaft located in the housing;

a plurality of rotors disposed on the output shaft and aligned with the stators so as to define a plurality of motor sub-units; and

separate power supplies and control systems for each motor sub-unit;

wherein each motor sub-unit is separately controllable by means of its associated power supply and control system.

In one embodiment, the output shaft comprises a single shaft with the rotors disposed thereon.

In another embodiment, the output shaft comprises a plurality of sub-shafts connected end to end. In this case, each rotor can be disposed on an associated sub-shaft. The sub-shafts can connected by means of articulated connections, and the housing can be articulated in the region of the connections.

In one preferred embodiment, the sub-shafts are connected by means of homocinetic couplings such that the instantaneous angle between the rotor and its associated stator is substantially identical for each motor sub-unit. The control systems are typically arranged to drive the phases of the motor sub-units together.

The stator windings can be provided in a variety of configurations and the control system arranged to address the stators so as to modify the characteristics of the motor.

In another preferred embodiment, the sub-shafts are connected by non-homocinetic couplings such that the instantaneous angle between each rotor and its associated stator is independent of those of the neighbouring motor sub-units to which it is connected. The control systems are typically arranged to drive the phases of each motor sub-units independently.

Another aspect of the invention provides borehole tool comprising an electric motor according to the first aspect of the invention.

### BRIEF DESCRIPTION OF THE DRAWINGS

FIG. 1 shows a schematic view of part of a motor section of a borehole tool according to a first embodiment of the invention; and

FIG. 2 shows a schematic view of a second embodiment of the invention.

### MODE(S) FOR CARRYING OUT THE INVENTION

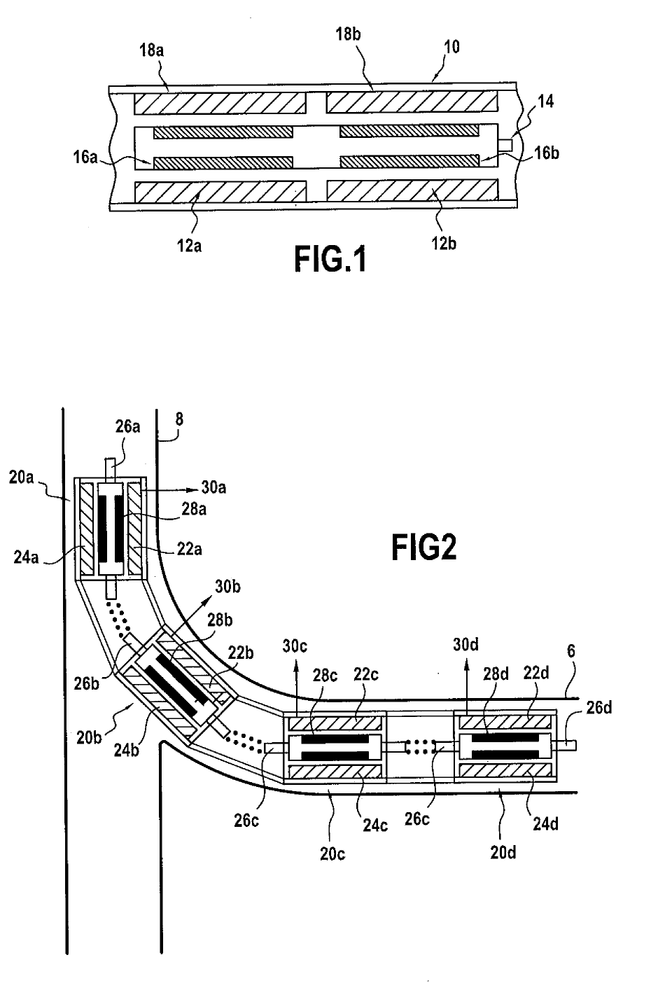

FIG. 1 shows a schematic view of part of a motor section of a borehole tool such as a drilling tool for drilling lateral boreholes. The motor comprises a cylindrical housing 10 of normal size for placement in a borehole. Stator windings 12a, 12b are provided inside the housing 10, spaced apart in the axial direction. An output shaft 14 is mounted for rotation inside the housing so as to be coaxial with the stators 12a, 12b. Rotors 16a, 16b are mounted on the output shaft 14 and positioned to align with the stator windings 12a, 12b so as to define motor sub-units. Each sub-unit is connected to a respective power supply and control system 18a, 18b. One particularly preferred form of motor sub-unit is formed from stators and rotors of the type used in conventional motors for borehole tools. Such motors are commonly synchronous brushless motors which are preferred for their great power density and high reliability, but other forms of motor such as asynchronous AC motors and DC motors can also be used.

By ‘stacking’ the motor sub-units, the torque from the stacked motor is multiplied by the number of sub-units stacked together, compared to a standard electrical motor composed of one rotor and one stator (i.e. one sub-unit). Thus an improved torque performance can be obtained for a given tool OD using essentially standard motor components.

Because the rotors 16a, 16b are mounted on a single shaft, the instantaneous speed of each rotor is the same, and the instantaneous angle between the rotor and its associated stator is identical on every motor sub-unit. Therefore, the entire motor assembly can be treated as a single motor and the control systems 18a, 18b operated so that the phase of each motor is driven together.

Proper mounting of the rotor in the stack of stators is important. For larger multiples of sub-units, manufacturing of the rotors on the shaft can become more complex in order to achieve the necessary clearance to be fitted into a stack of stators. Therefore, in another embodiment of the invention, multiple motor sub-units are coupled together, rather than using a single rotor. FIG. 2 shows a schematic view of an embodiment of this approach used to power a drilling tool that is used to drill a lateral borehole 6 being drilled from a main borehole 8.

In the embodiment of FIG. 2, each motor sub-unit 20a-d comprises a housing 22a-d having a stator winding 24a-d disposed therein and a shaft 26a-d on which is mounted a rotor 28a-d. Each sub unit 20a-d is connected to its own power supply and control system 30a-d.

Articulated joints 32a-c are used to connect the shafts 26 of adjacent motor sub-units 20 and to transmit torque, articulated housings 34a-c being provided around the joints 32a-c.

The shaft 26d of the final motor sub-unit 20d is connected to a drilling tool (not shown).

There are two possibilities for the articulated joints 32a-c: homocinetic couplings or non-homocinetic couplings. In homocinetic couplings (e.g. two universal joints) the tool behaves essentially in the same way as the embodiment of FIG. 1 described above and can be controlled in a likewise manner. In non-homocinetic couplings (e.g. flexible joints), the instantaneous angle of the rotor and its stator is not considered as identical for every motor sub-unit 20. In this case, each motor sub-unit 20a-d is controlled independently to obtain optimal efficiency for the entire assembly. One such approach is to fix a target speed for the output shaft of the assembly (i.e. shaft 26d) and to provide equal current to each motor sub-unit 20a-d of the assembly so that each provides its nominal power, and the assembly will be used at its optimal efficiency.

As the motor phases are driven separately in this scenario, this option provides built-in redundancy for the system. If a motor sub-unit fails, the motor failure will be detected by its control system and this single motor sub-unit can be disconnected from its drive electronics, leaving the rest of the assembly working on its own.

The large number of stators provides the opportunity to recombine stator windings in a homocinetic system in a large variety of configuration (Star vs. Delta, Series vs. Parallel) and consequently modify the characteristics of the assembled stacked motor as a mechanical gearbox would do. This ‘electrical’ gearbox does not require any mechanical parts. The gearbox ratio can be modified electrically downhole by rearranging the windings in a different pattern.

The control system can be arranged to provide active or passive load sharing by means of open or closed loop control.

Other changes can be made while staying within the scope of the invention.

1. An electric motor for use in a borehole tool, comprising
a housing;
a plurality of stator windings spaced along the inside of the housing;
an output shaft located in the housing;
a plurality of rotors disposed on the output shaft and aligned with the stators so as to define a plurality of motor sub-units; and
separate power supplies and control systems for each motor sub-unit;
wherein each motor sub-unit is separately controllable by means of its associated power supply and control system.

2. An electric motor as claimed in claim 1, wherein the output shaft comprises a single shaft with the rotors disposed thereon.

3. An electric motor as claimed in claim 1, wherein the output shaft comprises a plurality of sub-shafts connected end to end.

4. An electric motor as claimed in claim 3, wherein each rotor is disposed on an associated sub-shaft.

5. An electric motor as claimed in claim 3, wherein the sub-shafts are connected by means of articulated connections.

6. An electric motor as claimed in claim 5, wherein the housing is articulated in the region of the connections.

7. An electric motor as claimed in claim 5, wherein the sub-shafts are connected by means of homocinetic couplings such that the instantaneous angle between the rotor and its associated stator is substantially identical for each motor sub-unit.

8. An electric motor as claimed in claim 7, wherein the control systems are arranged to drive the phases of the motor sub-units together.

9. An electric motor as claimed in claim 7, wherein the stator windings are provided in a variety of configurations and the control system is arranged to address the stators so as to modify the characteristics of the motor.

10. An electric motor as claimed in claim 5, wherein the sub-shafts are connected by non-homocinetic couplings such that the instantaneous angle between each rotor and its associated stator is independent of those of the neighbouring motor sub-units to which it is connected.

11. An electric motor as claimed in claim 10, wherein the control systems are arranged to drive the phases of each motor sub-units independently.
